(19) United States
(12) Patent Application Publication
(10) Pub. No.: US 2014/0149882 A1
(43) Pub. Date: May 29, 2014

(54) SYSTEM, METHOD, AND APPARATUS FOR COLLABORATIVE CAX EDITING

(71) Applicant: Brigham Young University, Provo, UT (US)

(72) Inventors: Thomas Trevor Nysetvold, The Woodlands, TX (US); Joshua John Bennett, Cottonwood Heights, UT (US); Charles Gregory Jensen, Provo, UT (US)

(73) Assignee: Brigham Young University, Provo, UT (US)

(21) Appl. No.: 14/089,519

(22) Filed: Nov. 25, 2013

Related U.S. Application Data
(60) Provisional application No. 61/729,528, filed on Nov. 23, 2012.

(51) Int. Cl. H04L 29/06; G06F 3/0484

(52) U.S. Cl. CPC H04L 65/403; G06F 3/0484
USPC 715/751

(57) ABSTRACT

A method for collaborative CAx editing may include (1) enabling editing of a proprietary representation of an engineering object by a user, where the proprietary representation includes one or more features of the engineering object, (2) storing an operations log of the engineering object on a collaborative CAx server, (3) detecting creation of a feature of the engineering object within the proprietary CAx application, and (4) inserting a feature identifier corresponding to the feature within the proprietary representation of the engineering object. A system, apparatus, and computer-readable medium corresponding to the above method are also disclosed herein.

### BACKGROUND OF THE INVENTION

1. Field of the Invention

The claimed invention relates to computer aided technologies (CAx) such as computer aided design, engineering, analysis and manufacture in general and apparatus, systems, means, and methods for collaborative CAx editing in particular.

2. Description of the Related Art

Large design and engineering projects require coordination of the efforts of many designers or engineers. Designers and engineers may have various CAx tools that they have experience with, have been trained to use, or simply prefer. Existing CAx data may have been created using still other CAx tools. Each of these CAx tools may have incompatible file formats.

Efficient collaborative CAx editing should enable designers and engineers to each use their preferred CAx applications. Existing data should be incorporated into the design of an engineering object without having to be recreated or to undergo a lengthy conversion process that may result in significant data loss.

Existing CAx systems, however, are not well-suited to collaborative design and editing. Data files cannot simply be shared among several designers without coordinating editing functions and controlling access to features of the object design, or editing conflicts may result in data loss or corruption.

Accordingly, the present invention identifies and addresses a need for additional and improved systems and methods for collaborative CAx editing of engineering objects.

### BRIEF SUMMARY OF THE INVENTION

The embodiments disclosed herein have been developed in response to the present state of the art, and in particular, in response to the problems and needs in the art that have not yet been fully solved by currently available collaborative CAx editing systems, apparatus, and methods. Accordingly, the claimed inventions have been developed to provide a collaborative CAx editing apparatus, method, and system that overcomes shortcomings in the art.

In one example, a computer-implemented method for collaborative CAx editing may include (1) enabling editing of a proprietary representation of an engineering object by a user, where the proprietary representation includes one or more features of the engineering object, (2) storing an operations log of the engineering object on a collaborative CAx server, (3) detecting creation of a feature of the engineering object within the proprietary CAx application, and (4) inserting a feature identifier corresponding to the feature within the proprietary representation of the engineering object. The operations log of the engineering object may include a reference to the proprietary representation of the engineering object as a whole was well as to individual features of the engineering object.

In one example, the computer-implemented method further includes caching the proprietary representation and the operations log of the engineering object on the collaborative CAx server. In another example, the computer-implemented method further includes providing the proprietary representation of the engineering object to another CAx client.

In one embodiment, the operations log comprises a log of sequentially-generated feature definitions. The proprietary representation of the engineering object may correspond to a specific point-in-time within the log of sequentially-generated feature definitions.

One example of the computer-implemented method further includes initiating insertion of a placeholder feature and corresponding feature identifier within the operations log of the engineering object for features not directly supported by the operations log of the engineering object. Another example of the computer-implemented method further includes communicating the feature identifier and a definition of the feature to the CAx server. Apparatuses corresponding to the above methods are also disclosed herein.

Various elements of the present invention are combined into a system for collaborative CAx editing, which in one embodiment includes (1) a CAx client comprising at least one processor and configured to execute a proprietary CAx application and enable editing of a proprietary representation of an engineering object by a user, where the proprietary representation comprises one or more features for the engineering object, (2) a collaborative CAx server configured to store an operations log of the engineering object, and (3) a collaborative CAx synchronization module configured to detect creation of a feature for the engineering object within the proprietary CAx application and insert a feature identifier corresponding to the feature within the proprietary representation of the engineering object. The collaborative CAx synchronization module may also communicate a feature definition to the collaborative CAx server.

In some examples, the above-described method may be encoded as computer-readable instructions on a computer-readable-storage medium. For example, a computer-readable-storage medium may include one or more computer-executable instructions that, when executed by at least one processor of a computing device, may cause the computing device to (1) enable editing of a proprietary representation of an engineering object by a user, where the proprietary representation includes one or more features of the engineering object, (2) store an operations log of the engineering object on a collaborative CAx server, (3) detect creation of a feature of the engineering object within the proprietary CAx application, and (4) insert a feature identifier corresponding to the feature within the proprietary representation of the engineering object.

It should be noted that references throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram of one example of a computing and communications infrastructure that is consistent with one or more embodiments of the claimed invention;

FIG. 2 is a schematic diagram illustrating one embodiment of a collaborative CAx editing system of the claimed invention;

FIG. 3 is a flowchart diagram of one example of a collaborative CAx editing method that is consistent with one or more embodiments of the claimed invention; and

FIG. 4 is a schematic diagram of one example of a collaborative CAx editing system that is consistent with one or more embodiments of the claimed invention.

### DETAILED DESCRIPTION OF THE INVENTION

Some of the functional units described in this specification have been labeled as modules, in order to more particularly emphasize their implementation independence. Others are assumed to be modules. For example, a module or similar unit of functionality may be implemented as a hardware circuit comprising custom VLSI circuits or gate arrays, off-the-shelf semiconductors such as logic chips, transistors, or other discrete components. A module may also be implemented with programmable hardware devices such as field programmable gate arrays, programmable array logic, programmable logic devices or the like.

A module or a set of modules may also be implemented (in whole or in part) as a processor configured with software to perform the specified functionality. An identified module may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, the executable code of a module may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any tangible form capable of enabling execution of a program of machine-readable instructions on a digital processing apparatus. For example, a computer readable medium may be embodied by a flash drive, compact disk, digital-video disk, a magnetic tape, a Bernoulli drive, a magnetic disk, a punch card, flash memory, integrated circuits, or other digital processing apparatus memory device. A digital processing apparatus such as a computer may store program codes, associated data, and the like on the computer readable medium that when retrieved enable the digital processing apparatus to execute the functionality specified by the modules.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

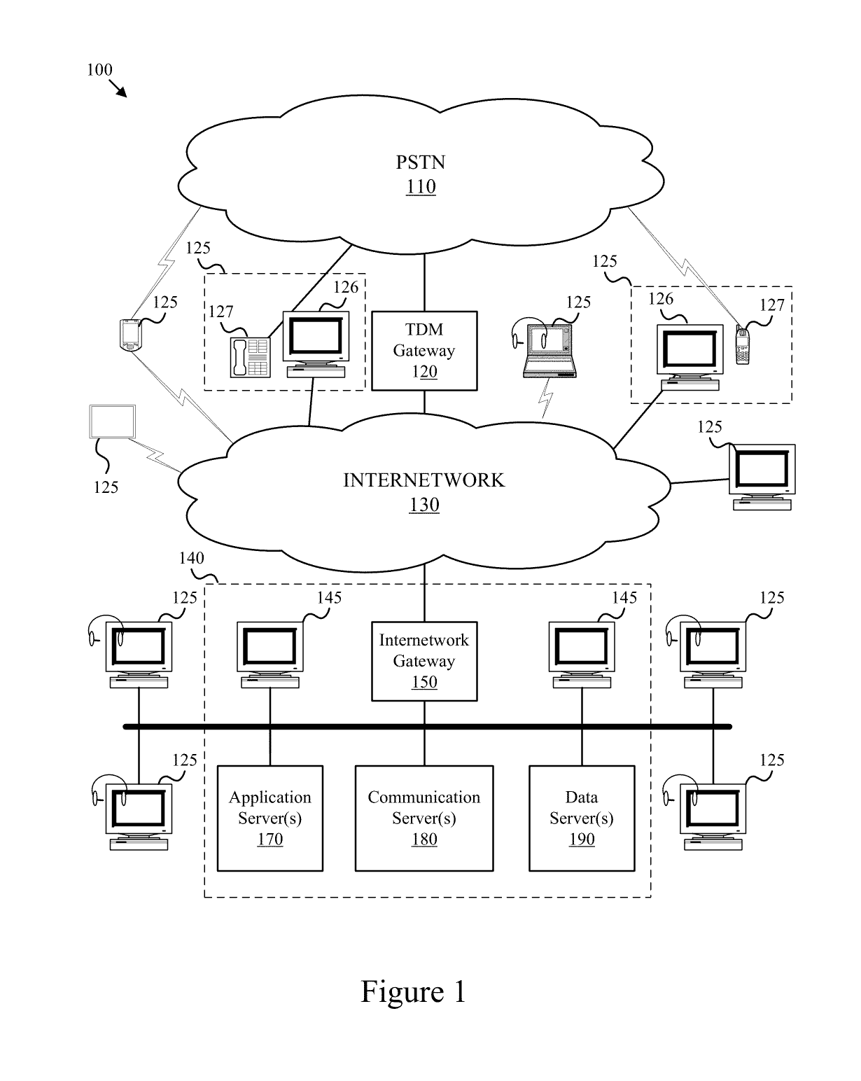

FIG. 1 is a block diagram of one example of a computing and communications infrastructure 100 that is consistent with one or more embodiments of the claimed invention. As depicted, the infrastructure 100 includes various systems, subsystems, and networks such as a public switched telephone network (PSTN) 110, a TDM gateway 120 connecting the PSTN to an inter-network 130, a variety of workstations 125, a data center 140 with administrative terminals 145, an inter-network gateway 150 connecting a local area network to the inter-network 130, and various servers such as application servers 170, communication servers 180, and data servers 190. The infrastructure 100 is one example of components that can be operably interconnected to provide an infrastructure for a computer-aided design, computer-aided engineering, or computer-aided manufacturing (CAx) system that includes a collaborative CAx editing system.

Each workstation 125 may include a separate computing device 126 and a communications device 127 or the computing device and communications device may integrated into the workstation 125. Examples of the communications device 127 include a phone, a VoIP device, an instant messaging device, a texting device, a browsing device, and the like. The computing devices 126 may enable graphical view selection. The communications devices 127 may enable users to communicate with other CAx system users.

The inter-network 130 may facilitate electronic communications between the various workstations and servers. In one embodiment, the inter-network 130 is the internet. In another embodiment, the inter-network 130 is a virtual private network (VPN).

Various servers such as blade servers within the data center 140 function cooperatively to facilitate concurrent collaborative editing of CAx models by local and remote users. For example, the application servers 170 may provide one or more CAx applications to the local and remote users. Some users may have the CAx applications installed on their local computing devices 126. Examples of CAx applications include Siemens NX, MSC Nastran, Dessault Systems CATIA and Solidworks, ANSYS, and the like.

The communication servers 180 may facilitate communications between the users through various channels or services such as VoIP services, email services, instant messaging services, short message services, and text messaging services. The workstations 125 may leverage such services for user to user communications via the communication servers 180 or via other available service platforms.

The data servers 190 or the like may store CAx models within various model files or records. The data servers may replicate copies of the models for use by various users. Some users may have a local copy of a model. As described herein, instead of requiring a particular user to assume control of a model file or record, updates to the model may be coordinated by one or more CAx applications including client versions, server versions, and cloud versions of such applications.

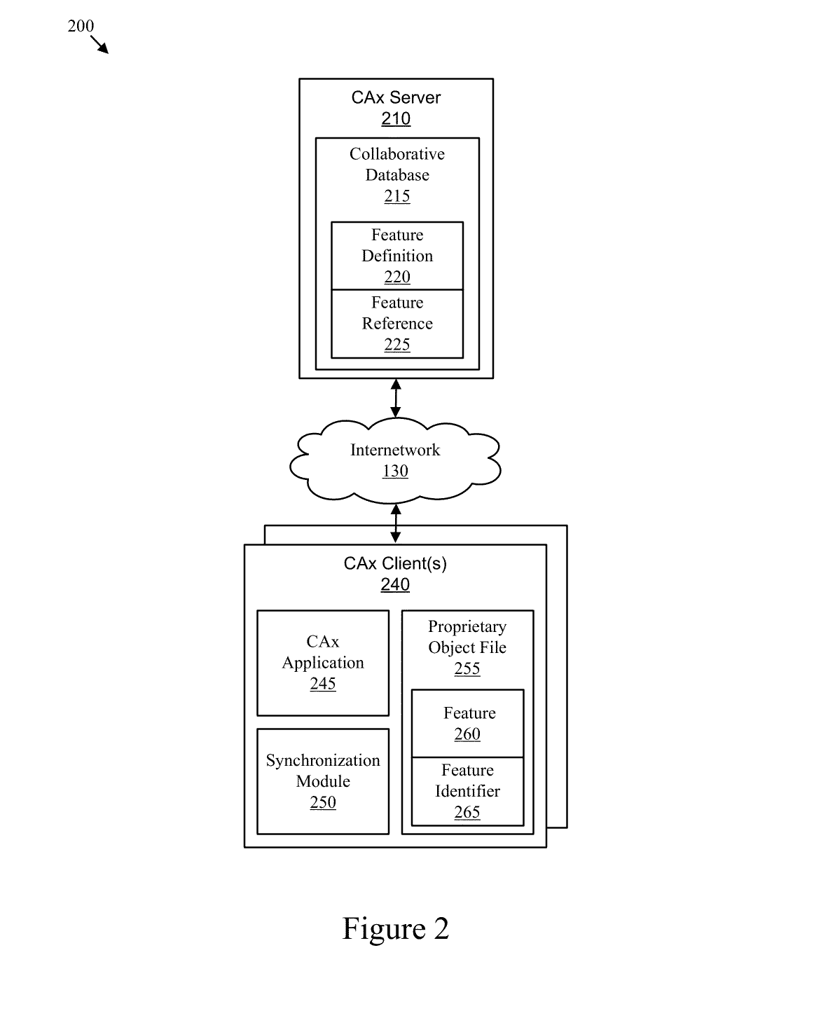

FIG. 2 is a block diagram of one example of a collaborative CAx editing system 200 that is consistent with one or more embodiments of the claimed invention. As depicted, and as will be explained in greater detail below, the collaborative CAx editing system 200 may include a variety of modules, including a CAx client 240 with at least one processor that may execute a proprietary CAx application 245 and enable editing of a proprietary representation of an engineering object by a user. The collaborative CAx editing system 200 may also include a collaborative CAx server 210 that may store a operations log of the engineering object. Collaborative CAx editing system 200 may also include a synchronization module 250 that may detect creation of a proprietary feature 260 of the engineering object within the proprietary CAx application 245 and insert a feature identifier 265 corresponding to the feature within the proprietary representation of the engineering object. The feature identifier 265 may correspond to, or be identical to, the feature reference 225.

As illustrated in FIG. 2, collaborative CAx editing system 200 may also include one or more data stores, such as proprietary object file 255 or collaborative database 215. In one embodiment, proprietary object file 255 may be configured to store a proprietary representation of an engineering object. Collaborative database 215 may be configured to store an operations log of the engineering object. Proprietary object file 255 and collaborative database 215 may represent portions of a single database or computing device or a plurality of databases or computing devices. For example, collaborative database 215 may represent portions of the computing and communications infrastructure 100 in FIG. 1.

Each of the modules may reside on a single computing device (i.e. node) or be collaboratively partitioned onto multiple devices or nodes. The modules may be primarily or wholly comprised of software codes and associated data that are executed and processed by a digital processing apparatus such as a computer to provide the specified functionality.

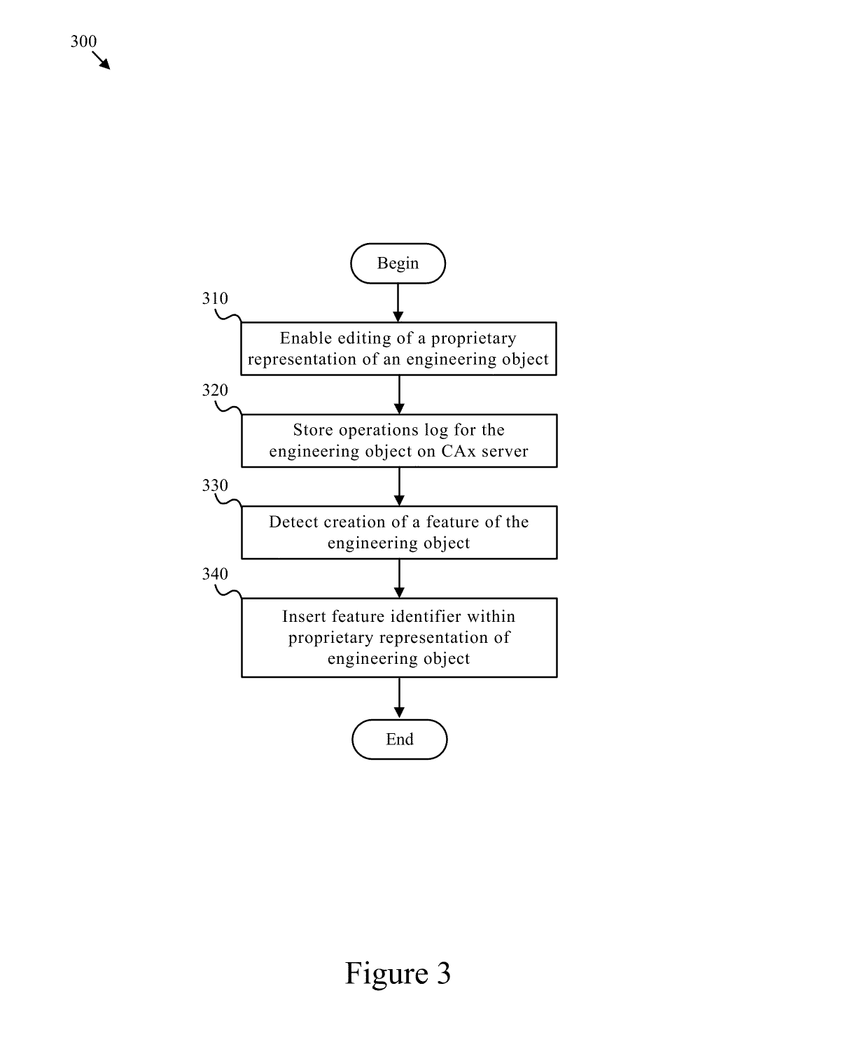

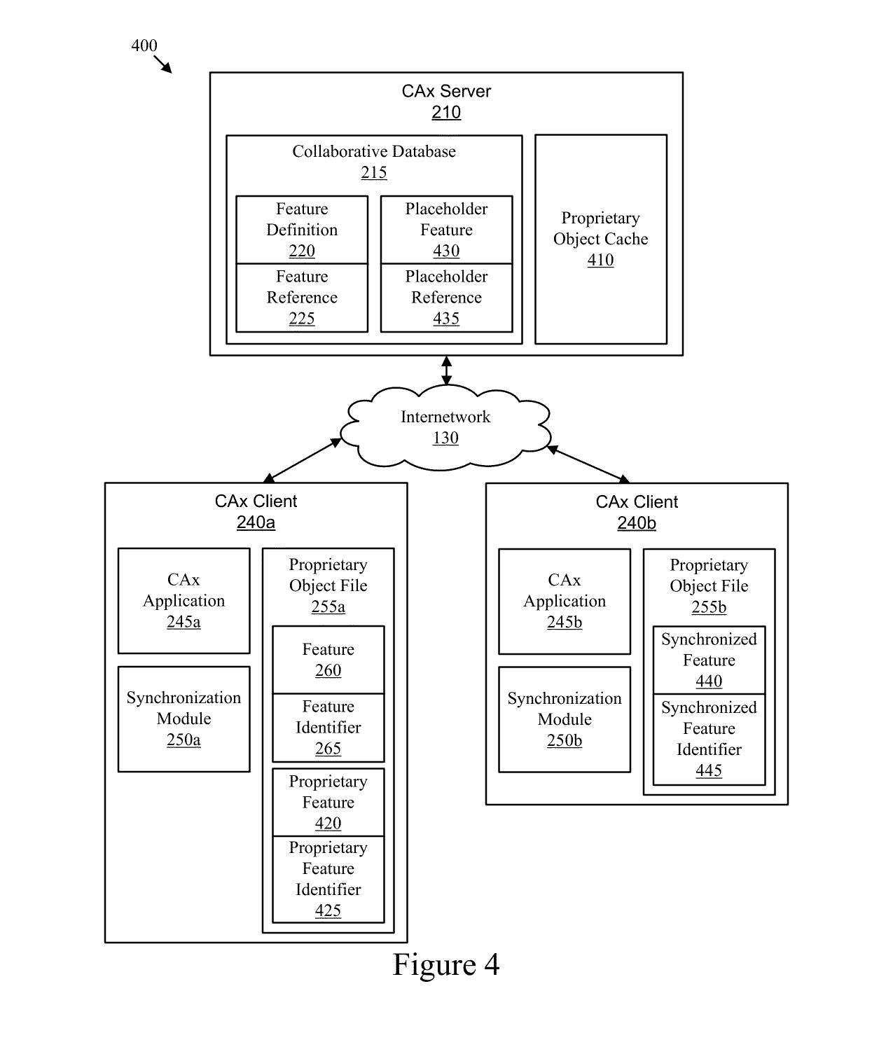

FIG. 3 is a flow diagram of a collaborative CAx editing method 300. The steps (i.e., operations) shown in FIG. 3 may be performed by any suitable computer-executable code and/or computing system and in some cases need not be executed sequentially or in the depicted order. In some embodiments, the steps shown in FIG. 3 may be performed by one or more components of computing and communications infrastructure 100 in FIG. 1, system 200 in FIG. 2, and/or system 400 in FIG. 4.

As illustrated in FIG. 3, at step 310 one or more of the systems described herein may execute a proprietary CAx application and enable editing of a proprietary representation of an engineering object by a user. For example, at step 310 CAx client 240 may, as part of computing device 200 in FIG. 2, execute CAx application 245 and enable editing of a proprietary representation of an engineering object by a user. CAx application 245 may store the proprietary representation of the engineering object in proprietary object file 255. The proprietary representation may include one or more features of the engineering object, such as proprietary feature 260.

As used herein, the phrase “engineering object” generally refers to a conceptual design produced to show the look or function of an object before it is built or made. The design may be incorporated in representations such as plans, drawings, diagrams, schematics, blueprints, sketches, maps, or models. The design may include one or more “features,” i.e., distinctive attributes that may be represented by one or more geometries or parameters.

As used herein, the phrase “proprietary representation” generally refers to a data format associated with a CAx application. A proprietary representation of an engineering object may be vendor specific and typically cannot be directly edited by a CAx application other than those available from the vendor or licensed by the vendor. Typically, a conversion process is required for a CAx application from another vendor to edit the engineering object. The conversion process may result in the loss of data.

At step 320 one or more of the systems described herein may store an operations log for the engineering object on a collaborative CAx server. For example, at step 320 collaborative CAx server 210 may, as part of computing device 200 in FIG. 2, store an operations log of the engineering object on a collaborative CAx server 210. The operations log may be stored in a collaborative database 215, and may include one or more feature definitions, such as feature definition 220.

As used herein, the phrase “operations log” generally refers to a log of CAx operations that may or may not be associated with a single proprietary CAx application. For example, the operations log may be a vendor-neutral log of feature definitions that facilitates collaborate editing between various proprietary CAx applications.

Collaborative CAx server 210 may store an operations log of the engineering object in various ways. In one embodiment, the operations log of the engineering object comprises a log of sequentially-generated feature definitions. The engineering object may be reconstructed within various CAx applications by regenerating the features comprising the engineering object in sequence. The feature definitions within the operations log may be readily translatable to editing commands within each CAx application by a synchronization module 250 associated therewith.

The operations log of the engineering object may include references to features within the proprietary representation of the engineering object. For example, as depicted in FIG. 2, feature definition 220, corresponding to proprietary feature 260 and to feature identifier 265, may have an associated feature reference 225 associating feature definition 220 with proprietary feature 260. In some embodiments, the feature identifier 265, corresponds directly to the feature reference 225. In one embodiment, the feature identifier 265 and the feature reference 225 are identical. Synchronization module 250 may use feature reference 225 to identify the corresponding proprietary feature 260 within proprietary object file 255 via the feature identifier 265. In one embodiment, feature reference 225 is a globally-unique identifier (GUID) associated with proprietary feature 260.

In one embodiment, the proprietary representation of the engineering object corresponds to a point-in-time within the log of sequentially-generated feature definitions. The point in time may correspond to a snapshot or revision marker within the log. In a collaborative CAx editing environment, editing of the engineering object may take place while a client is offline. The sequentially-generated feature definitions may continue to be created in the operations log of the engineering object. When the client reconnects with the operations log of the engineering object, subsequently-generated feature definitions created after the point-in-time are applied to the proprietary representation to synchronize the proprietary representation with the operations log.

Returning to FIG. 3, at step 330 one or more of the systems described herein may detect creation of a feature of the engineering object within the proprietary CAx application. For example, at step 330 collaborative CAx synchronization module 250 may, as part of CAx client 240 in FIG. 2, detect creation of a feature of the engineering object within the proprietary CAx application. For example, collaborative CAx synchronization module 250 may detect creating of proprietary feature 260 in proprietary object file 255.

The collaborative CAx synchronization module may detect creation of a feature of the engineering object within the proprietary CAx application in any suitable manner. In one embodiment, the collaborative CAx synchronization module is a plugin for the CAx application, and detects creation of a feature of the engineering object using an application programming interface (API) provided by the CAx application to permit additional functions to execute when a feature is created.

At step 340 of FIG. 3, one or more of the systems described herein may insert a feature identifier corresponding to the feature within the proprietary representation of the engineering object. For example, at step 340 synchronization module 250 may, as part of CAx client 240 in FIG. 2, insert feature identifier 265 corresponding to proprietary feature 260 within the proprietary representation of the engineering object stored in proprietary object file 255.

As used herein, the phrase “feature identifier” generally refers to a data item that relates a proprietary feature in a proprietary object file to a feature definition in a collaborative database. In one embodiment, the feature identifier is the index of the feature definition record in the collaborative database.

In one embodiment, the feature identifier is stored in a parameter for the feature within the proprietary representation of the engineering object. By storing the feature identifier within the proprietary representation of the engineering object, the relationship between the proprietary feature and the corresponding feature definition within the operations log is persistent between editing sessions on the CAx client. The feature identifier may be a globally unique identifier. In some embodiments, the feature identifier is represented in a text format to facilitate storage and retrieval within various CAx applications.

FIG. 4 is a schematic diagram of one example of a collaborative CAx editing system 400 that is consistent with one or more embodiments of the claimed invention. In addition to the internetwork 130 of the computing and communications infrastructure 100 of FIG. 1 and modules of the collaborative CAx editing system 200 of FIG. 2, collaborative CAx editing system 400 includes a second CAx client. Corresponding modules of the two CAx clients 240 are appended with reference letters ‘a’ and ‘b.’

In one embodiment, the proprietary representation and the operations log of the engineering object may be cached by the collaborative CAx server. For example, as part of collaborative CAx editing system 400 in FIG. 4, CAx server 210 may cache the proprietary representation of the engineering object in proprietary object cache 410. Regenerating a proprietary representation of an engineering object from sequentially-generated feature definitions in an operations log of the object may be a computationally-intensive and time-consuming process. Caching the proprietary representation of the engineering object on the CAx server with the operations log accelerates the loading of the engineering object on a CAx client on which the proprietary representation is usable by the CAx client and has not yet been loaded into memory (such as following a system crash of the CAx client, or when a new CAx client is added to the collaborative editing system).

In one embodiment, the proprietary representation of the engineering object may be provided to another (a second) CAx client. When the second CAx client adds or changes a feature in the proprietary representation, an instance of the collaborative CAx synchronization module corresponding to the second client may communicate the feature identifier and a corresponding feature definition to the CAx server. The collaborative CAx synchronization module (associated with the first CAx client) may then receive a feature identifier and the feature definition corresponding to the feature created the second CAx client and create a corresponding local feature. For example, as part of collaborative CAx editing system 400, synchronization module 250b on CAx client 240b may create feature definition 220 in collaborative database 215 on CAx server 210. CAx server 210 may notify synchronization module 250a on CAx client 240a of the new feature in the collaborative database 215. Synchronization module 250a may then create synchronized feature 440 in proprietary object file 255a on CAx client 240a, corresponding to feature 260 in proprietary object file 255b on CAx client 240b.

In some embodiments, the CAx synchronization module may initiate insertion of a placeholder feature and corresponding feature reference within the operations log of the engineering object for features not directly supported by the operations log of the engineering object. For example, as depicted in collaborative editing system 400 in FIG. 4, proprietary feature 420 may be created in proprietary object file 255a on CAx client 240a. Synchronization module 250a may initiate creation of placeholder feature 430 and associated placeholder reference 435 in collaborative database 215 on CAx server 210. Features represented by a placeholder may not be editable by another CAx application, but the placeholder reference 435 maintains an association between the database record for placeholder feature 430 and the proprietary representation of the data in the proprietary object file 255a. Placeholder features may be referenced by other features. For example, a sheet body that could not be created or edited in collaborative database 215 may be represented by a placeholder feature and referenced by a split body feature.

As explained above, the collaborative CAx system may associate features in a proprietary representation of an engineering object with corresponding feature definitions in an operations log of the engineering object. A synchronization module, which may be a plug-in to a CAx application executing on a CAx client, may synchronize features between the proprietary and operations logs of the engineering object. As new features are created and edited on one CAx client and synchronized to the vendor-neutral database, synchronization modules on other CAx clients may synchronize the features from the vendor-neutral database to local copies of the proprietary representation of the engineering object.

The collaborative CAx editing system may maintain identifiers and references associating the proprietary and operations log representations of features of the engineering object in non-transitory storage, to prevent the loss of data in the event of system failure of either a CAx client or the CAx server. Caching the proprietary representation of the engineering object in a proprietary object cache on the CAx server may facilitate faster recovery from the system failure of a CAx client.

The proprietary representation of an engineering object may be a “checkpoint” or point-in-time within a sequence of feature definitions created in operations log. The synchronization module may bring the proprietary representation “up to date” by creating features in the proprietary representation that were created in the operations log subsequent to the point-in-time represented by the proprietary representation.

The various elements of the collaborative CAx system, method, and apparatus function cooperatively to facilitate productive collaborative CAx editing. The preceding depiction of the collaborative CAx system and other inventive elements described herein are intended to be illustrative rather than definitive. Similarly, the claimed invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
a CAx client comprising at least one processor and configured to execute a proprietary CAx application and thereby enable editing of a proprietary representation of an engineering object by a user, wherein the proprietary representation comprises one or more features for the engineering object;
a collaborative CAx server configured to store an operations log of the engineering object;
a collaborative CAx synchronization module configured to detect creation of a feature for the engineering object within the proprietary CAx application and insert a feature identifier corresponding to the feature within the proprietary representation of the engineering object.

2. The system of claim 1, wherein the operations log of the engineering object includes a reference to the proprietary representation of the engineering object at a specific point-in-time.

3. The system of claim 2, wherein the proprietary representation and the operations log of the engineering object are cached by the collaborative CAx server.

4. The system of claim 2, wherein the proprietary representation of the engineering object is provided to another CAx client.

5. The system of claim 2, wherein the operations log comprises a log of sequentially-generated feature definitions.

6. The system of claim 5, wherein the proprietary representation of the engineering object corresponds to a point-in-time within the log of sequentially-generated feature definitions.

7. The system of claim 1, wherein the CAx synchronization module is further configured to initiate insertion of a placeholder feature and corresponding feature reference within the operations log of the engineering object for features not directly supported by the operations log of the engineering object.

8. The system of claim 1, wherein the collaborative CAx synchronization module is a plugin for the CAx application.

9. The system of claim 1, wherein the collaborative CAx synchronization module is further configured to communicate the feature identifier and a description of the feature to the CAx server.

10. The system of claim 1, wherein the feature identifier is stored in a parameter for the feature within the proprietary representation of the engineering object.

11. The system of claim 1, wherein the collaborative CAx synchronization module is further configured to receive another feature identifier and associated description corresponding to a feature created on another CAx client and create a corresponding local feature therefrom.

12. A computer-implemented method comprising:
storing a operations log of an engineering object on a collaborative CAx server;
detecting creation of a feature of the engineering object within a proprietary CAx application;
inserting a feature identifier corresponding to the feature within the proprietary representation of the engineering object.

13. The computer-implemented method of claim 12, wherein the operations log of the engineering object includes a reference to the proprietary representation of the engineering object.

14. The computer-implemented method of claim 13, further comprising caching the proprietary representation and the operations log of the engineering object on the collaborative CAx server.

15. The computer-implemented method of claim 13, further comprising providing the proprietary representation of the engineering object to another CAx client.

16. The computer-implemented method of claim 13, wherein the operations log comprises a log of sequentially-generated feature definitions.

17. The computer-implemented method of claim 16, wherein the proprietary representation of the engineering object corresponds to a point-in-time within the log of sequentially-generated feature definitions.

18. The computer-implemented method of claim 12, further comprising initiating insertion of a placeholder feature and corresponding feature identifier within the operations log of the engineering object for features not directly supported by the operations log of the engineering object.

19. The computer-implemented method of claim 12, further comprising communicating the feature identifier and a description of the feature to the CAx server.

20. A non-transitory computer-readable medium comprising one or more computer-executable instructions that, when executed by a computing device, cause the computing device to:
store a operations log of an engineering object on a collaborative CAx server;
detect creation of a feature of the engineering object within a proprietary CAx application;
insert a feature identifier corresponding to the feature within the proprietary representation of the engineering object.
